(19) United States
(12) Patent Application Publication
(10) Pub. No.: US 2016/0123229 A1
(43) Pub. Date: May 5, 2016

(54) SYSTEM AND METHOD FOR PROVIDING AIR-COOLING, AND RELATED POWER GENERATION SYSTEMS

(71) Applicant: GENERAL ELECTRIC COMPANY, SCHENECTADY, NY (US)

(72) Inventors: Ching-Jen Tang, Watervliet, NY (US); Andrew Philip Shapiro, Niskayuna, NY (US)

(21) Appl. No.: 14/880,520

(22) Filed: Oct. 12, 2015

Related U.S. Application Data
(60) Provisional application No. 62/074,877, filed on Nov. 4, 2014.

(51) Int. Cl. F02C 7/18; F24F 5/00

(52) U.S. Cl. CPC F02C 7/185; F24F 5/0035

(57) ABSTRACT

A cooling system for providing chilled air is disclosed, including a cooling coil; an evaporator and absorber contained within a vacuum chamber; and a desiccant that absorbs water vapor from the cooling process. The system also includes an external heat source for treating the desiccant; along with a regenerator to make the desiccant re-useable. At least one heat exchanger is also included, along with a source of make-up water in communication with the cooling coil. Related processes are also disclosed, along with a gas turbine engine that includes or is arranged in association with the cooling system.

### CROSS REFERENCE TO RELATED APPLICATIONS

The present application claims priority to U.S. Provisional Application No. 62/074,877, filed Nov. 4, 2014, and which is incorporated by reference herein in its entirety.

### BACKGROUND

This disclosure is generally directed to methods and systems for cooling air. In some specific embodiments, the disclosure is related to air-cooling systems useful for incorporation into power generation systems.

A large number of industries require cooled air that is also dry. Examples include beverage manufacturers such as breweries; as well as food packaging and storage facilities. Moreover, homes, apartment buildings, municipal buildings, and countless office buildings and indoor-recreational facilities throughout the world require air-conditioning systems that can provide a highly controlled environment, in terms of air temperature and humidity.

Yet another important use for cooled air can be found in the case of “air-breathing” engines, such as gas turbines. Gas turbine engines are used in many applications, including aircraft, power generation, and marine systems. (The desired engine operating characteristics vary, of course, from application to application). When these types of engines operate in an environment in which the ambient temperature is reduced in comparison to other environments, the engines are usually capable of operating with a higher shaft horse power (SHP) and an increased output, without increasing the core engine temperature to unacceptably high levels. Conversely, when the ambient temperature (air inlet temperature) is increased, the efficiency of the engine can decrease dramatically. For example, for certain types of gas turbine engines, a 50° F. (10° C.) increase in ambient temperature can cause more than a 25% loss of power. Moreover, the temperature increase can lead to increased fuel consumption, as well as higher levels of NOx emissions.

To address the need for cool, dry air for all of these purposes, a large number of systems and techniques have been developed. Many of these techniques rely on vapor compression systems that take advantage of the expansion and compression of a refrigerant to provide cooling for ambient spaces. Another type of system uses a hydroscopic material, such as a desiccant, to remove water from an airstream, cooling the ambient environment. Various combinations of these systems have also been developed. Evaporative cooling techniques are especially attractive in some circumstances, in that they don't rely on energy-intensive, mechanical compression.

However, challenges remain in the design of systems based on evaporative cooling techniques—even the more advanced systems that have been developed recently. The systems are often complex, relying on a closed-loop design that often requires a condenser as part of a refrigeration unit within the system. The evaporator design can also involve some complexities, requiring at least one built-in cooling system within the unit. Furthermore, in the case of larger power generation systems now being developed, cooling systems with an even greater capacity for delivering cooled air to an engine compressor will be necessary in the future. Thus, improved systems and processes would be welcome in the art.

### SUMMARY OF THE INVENTION

One embodiment of the invention is directed to a cooling system for providing chilled air. The system comprises:

(a) a cooling coil configured to accept air at a higher temperature and emit air at a lower temperature by passage through a flow of coolant water in the coil, resulting in a content of relatively warm water;

(b) an evaporator contained within a vacuum chamber, and in communication with the cooling coil; said evaporator configured to allow the passage of the relatively warm water therethrough, and to absorb heat from the warm water, thereby reducing the temperature of the water, while also forming a content of water vapor;

(c) an absorber contained in the vacuum chamber, and configured to accept the water vapor formed in the evaporator; while also configured to accommodate the flow of a concentrated desiccant that is capable of absorbing the water vapor and thereby becoming diluted and heated;

(d) an external heat source in contact with at least a portion of the desiccant, so as to further heat the desiccant;

(e) a regenerator that is capable of receiving at least a portion of the further-heated desiccant, said regenerator configured to accept and direct external air to the desiccant, thereby causing a release of at least some of the water content in the desiccant, to the atmosphere, so as to re-concentrate the desiccant to a selected concentration value;

(f) at least one heat exchanger that is capable of accepting the re-concentrated desiccant and lowering the temperature of the desiccant to a temperature that allows the desiccant to absorb water vapor formed in the evaporator, said heat exchanger being in communication with the absorber, to allow the return of the lower-temperature desiccant to the absorber; and

(g) a source of make-up water in communication with at least the cooling coil, configured to replenish water lost during operation of the cooling system.

Another embodiment of the invention is directed to a gas turbine engine, e.g., one that includes a compressor; a combustor, and a turbine, coupled in flow communication with an inlet region of the compressor. The turbine engine includes a cooling system capable of providing cooling air to an inlet region of the compressor. The cooling system is described in detail, in the disclosure which follows.

Still another embodiment of the invention is directed to a method for providing chilled air to a gas turbine engine as described herein, comprising the steps of:

(i) flowing relatively warm air through coolant water in a cooling coil, and then into an inlet in the compressor, wherein the cooling coil transforms the relatively warm air into chilled air; and wherein the interaction of the warm air with the coolant water transforms the water into relatively warm water;

(ii) directing the relatively warm water through an evaporator contained within a vacuum chamber, and in communication with the cooling coil; wherein the evaporator is configured to allow the passage of the relatively warm water therethrough, and to absorb heat from the warm water, thereby reducing the temperature of the water so that it can be directed back to the cooling coil; while also forming a content of water vapor;

(iii) directing the water vapor from the evaporator to an absorber; while also directing a concentrated desiccant to the absorber, so that the desiccant absorbs the water vapor and becomes diluted with a content of water.

(iv) contacting the heated, diluted desiccant with an external heat source, so as to further increase the temperature of the desiccant;

(v) directing at least a portion of the further-heated desiccant to a regenerator and exposing the desiccant to external air directed into the regenerator, so as to cause a release of at least some of the water content in the desiccant, thereby re-concentrating the desiccant to a selected concentration value; and

(vi) directing the re-concentrated desiccant to the absorber.

### DESCRIPTION OF THE DRAWINGS

FIG. 1 is a schematic of a cooling system according to one embodiment of the invention.

FIG. 2 is a cross-sectional depiction of an evaporator/absorber unit for a cooling system according to some embodiments of the invention.

FIG. 3 is a schematic of a cooling system according to another embodiment of the invention.

### DETAILED DESCRIPTION

In regard to this disclosure, any ranges disclosed herein are inclusive and combinable (e.g., compositional ranges of “up to about 25 wt %”, or more specifically, “about 5 wt % to about 20 wt %”, are inclusive of the endpoints and all intermediate values of the ranges). Moreover, the terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. Moreover, approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

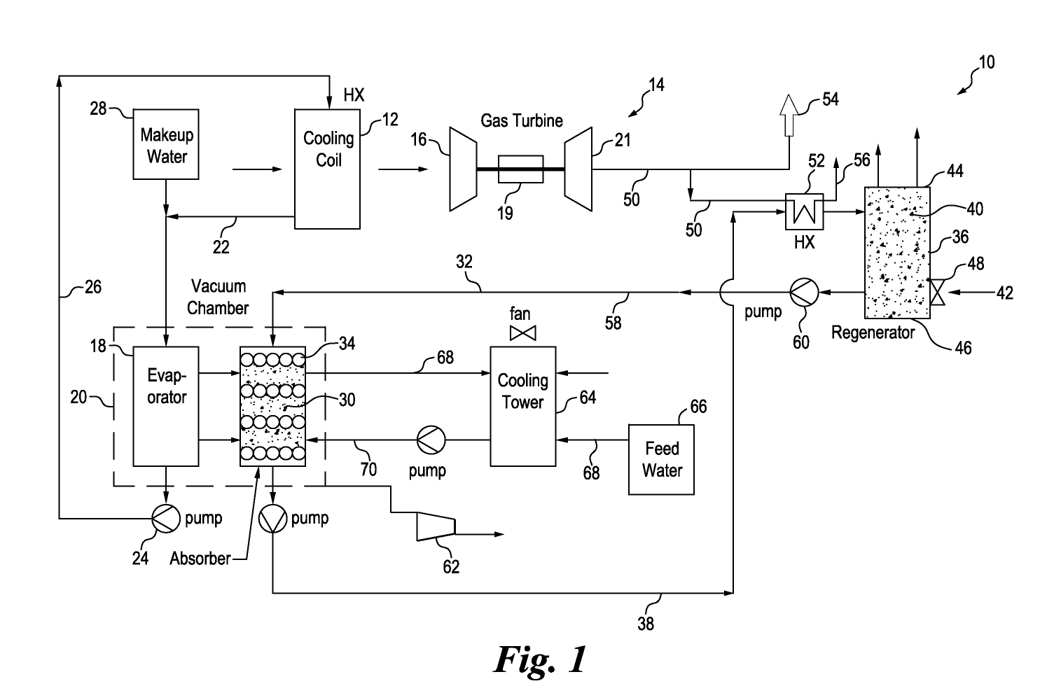

FIG. 1 is a schematic, cross-sectional view of a cooling system 10 according to one embodiment of the present invention. The system includes a cooling coil 12 that is configured to accept air at a higher temperature and then emit air at a lower temperature. The lower-temperature air can be used for a variety of purposes, as illustrated previously. Non-limiting examples include air-conditioning systems used in a wide variety of stationary locations; vehicles; machines; and other devices. In many instances, the cooling system can lower the temperature of air by about 2° C. to 35° C., depending, of course, on the end use application.

As also explained above, one important use for the cooling system is a power generation device that requires an inflow of air, such as a gas turbine engine 14, shown in FIG. 1. A decrease in the temperature of the inlet air directed into compressor 16 can provide much greater power and efficiency for the engine. As one example for an industrial gas turbine, a cooling system like that described herein can lower the temperature of ambient air (e.g., air as hot as about 40° C.) to a temperature in the range of about 10-15° C. For many applications, this would be referred to as “chilled” air.

Coolant coil 12 usually includes one or more tubes or conduits through which cold water flows, interacting with the relatively warm air, and providing the cooling effect that results in the chilled air. Cooling coils of this type are known in the art, and can often be thought of as “air-to-water heat exchangers”. The transfer of heat from the air to the water results in a content of relatively warm water, as compared to the initially-cold water.

The relatively warm water from the cooling coil (along with make-up water, as described below) is directed through an evaporator 18. The evaporator is usually contained within a conventional type of vacuum chamber 20. (Any suitable conduit/pipe 22 can be used to channel the water to the evaporator). Various types of evaporators can be used for the present invention; and all perform the general function of converting at least a portion of a liquid medium into its gaseous form, i.e., by absorbing heat from the warm water. Non-limiting examples of suitable evaporator-types include falling film evaporators (e.g., falling film plate evaporators) and multiple-effect evaporators. In some preferred embodiments, the evaporator is configured to absorb enough heat from the warm water to lower the temperature of the water by at least about 2° C. Moreover, preferred embodiments call for the evaporator itself to be configured to function in the absence of a cooling coil. Additional information regarding preferred evaporator systems is provided below. The cooled water can then be pumped back (e.g., using pump 24) to the cooling coil 12, for re-use, via conduit 26, for example.

In most embodiments, cooling system 10 includes an external source of make-up water 28. The make-up water replenishes water lost during any cycle in operation of the system, e.g., during operation of the evaporation or absorption cycles; along with water which will be lost during passage of water or vapor through any conduits in the system. It is usually introduced from any suitable supply at ambient temperature. Typically, the make-up water combines with warm water exiting the cooling coil via conduit 22, and the combined flow enters evaporator 18. The system with an external source of make-up water can be thought of as an “open-loop system”, which has advantages over a closed-loop system. For example, the open loop system is simpler in design than closed systems that may require a greater number of vacuum compartments. The open-loop design system also allows for easier integration with other components in the entire cooling system, and can be operated less expensively in some situations. The open-loop design can also exhibit a faster response to changes in various environmental conditions and material characteristics, such as water temperature; air temperature; and water vapor content.

As noted above, passage of the warm water through the evaporator results in the formation of a content of water vapor. In preferred embodiments, the water vapor is directed to an absorber 30. The absorber is usually contained within the same vacuum chamber 20 as the evaporator. In some cases, conduits may be used to direct the water vapor to the absorber. However, a small pressure difference between the two units (i.e., higher pressure in the evaporator, lower pressure in the absorber) is usually sufficient to direct all of the water vapor to absorber 30.

In addition to accepting the water vapor, the absorber 30 also accommodates a flow of a concentrated desiccant 32. As described below, the desiccant is carried through, directly or indirectly, from a regenerator. The desiccant comprises a material that is capable of absorbing the water vapor. Absorption of the water vapor usually results in an increase in the temperature of the desiccant, while also diluting the desiccant (in the case of a liquid desiccant).

A number of desiccants may be employed. Non-limiting examples include lithium chloride (LiCl), lithium bromide (LiBr), calcium chloride (CaCl₂), zinc bromide; various alkali nitrates and ionic liquids; as well as activated carbon, zeolites, and silica gel. In many embodiments, it is preferable to employ liquid desiccants, or those that can be prepared as liquids, e.g., aqueous solutions. Specific examples include LiBr and LiCl. However, solid desiccants can be used in some instances, with steps being taken to ensure that the solid material be arranged for maximum contact with the water vapor.

As alluded to above, when the concentrated desiccant 32 flows through the absorber 30, the desiccant absorbs the water vapor from the evaporator, and becomes diluted. In some embodiments, vapor transfer to the desiccant is enhanced by lowering the temperature of the desiccant, using an optional heat exchanger mechanism 34, here incorporated into the absorber itself. Various types of heat exchangers may be used, and many comprise a series of heat exchange pipes, as depicted in FIG. 1. The presence of the heat exchanger may remove enough heat so that the temperature-rise in the desiccant is not as great as in the absence of an integrated heat exchanger, as mentioned below.

The diluted desiccant, having absorbed most or all of the water from the water vapor, is then routed to a regenerator 36, via any suitable conduit 38. As alluded to previously, the desiccant gives off moisture in the regenerator, so that the desiccant can be used again in the absorber. Many different types of regenerators can be used. In some embodiments, they are filled or partially filled with various types of packing media 40 (FIG. 1), through which the diluted desiccant travels in a path through the regenerator.

As a non-limiting illustration, a suitable nozzle (not shown) can be situated at or near the top end 44 of the regenerator, through which the desiccant can flow. The nozzle can spray droplets of the desiccant into the regenerator chamber, so that it travels in a downward path through the packing media, exiting at or near regenerator bottom 46. Movement of the desiccant is enhanced by exposure to a source of external air 42, which can be blown by a fan 48, for example, into the regenerator. The extended residence time of the desiccant through the packing ensures maximum, desired removal of water from the desiccant. In this manner, the desiccant is re-concentrated to a desired concentration value.

In some embodiments, the heated, diluted desiccant being transported from absorber 30 is contacted with at least one external heat source. This will increase the temperature of the desiccant, decreasing the amount of energy needed to remove water during passage through the regenerator. In some especially preferred embodiments, the external heat source is exhaust gas that exits gas turbine engine 14. As those skilled in the art understand, industrial gas turbines with a typical output rating of about 40 MW can emit/discharge large amounts of exhaust gas from one or more suitable thermal outlets, at temperatures in the range of about 400° C.-550° C. Any portion of the high-temperature exhaust gas (waste heat) can be directed along pathway 50 to a suitable heat exchanger 52 or other type of recuperator device, thereby providing further heat to the desiccant. (The remainder 54 of exhaust from the power generation device is usually released to the atmosphere). Any excess moisture 56 exiting heat exchanger 52 can also be released to the atmosphere. Use of the exhaust gas provides an efficient means of lowering the amount of energy needed in the regeneration stage, to recycle the desiccant. In some embodiments, a direct conduit can extend from the external heat source to the desiccant, i.e., in the absence of heat exchanger 52.

The re-concentrated desiccant can then be directed back to the absorber, along pathway/conduit 58, with at least one pump 60 often being used to move the desiccant along the pathway. However, in many embodiments, pump 60 may not be necessary. This is due to the fact that the regenerator unit is maintained at atmospheric pressure, while the absorber is maintained under vacuum. The pressure difference is often sufficient, on its own, to move the desiccant solution from the regenerator to the absorber. The desiccant at this stage (being returned to the absorber) is at a temperature low enough to permit it to absorb additional water vapor within the absorber, thereby completing the cycle within the cooling system.

Additional features may also be present in the cooling system of FIG. 1. In some embodiments, a pump or compressor 62 may be used to pump out gasses that might interfere with operations going on within vacuum chamber 20. For example, the pump may be used to continuously remove non-dissolvable gasses (i.e., gasses other than water vapor), such as nitrogen, oxygen, and hydrogen.

In other embodiments, a cooling tower 64 can be incorporated into the absorber section of the cooling system. The cooling tower can be supplied from a feed water source 66, and can be connected to the absorber through entry line 68 and exit line 70. In this manner, the cooling tower circuit functions to remove additional heat resulting from the absorption of water vapor in the absorber. (Feed water source 66 can also be supplied from make-up water source 28, through appropriate conduits that are not illustrated).

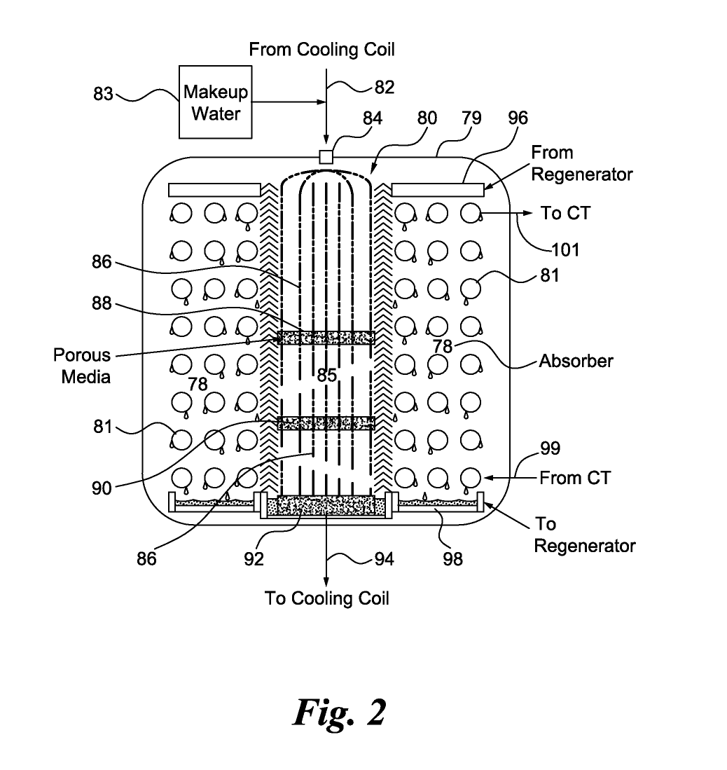

In some embodiments, particular types of evaporators and absorbers are preferred for the cooling system 10. FIG. 2 depicts a combined evaporator-absorber unit contained within a suitable vacuum chamber 79. The absorber 78 includes a set of heat transfer tubes 81, usually concentric, and surrounding evaporator 80, which includes a central region 85. The tubes within the absorber accelerate the absorption of water vapor from the evaporator.

The evaporator 80 includes at least one platform or layer of a porous material, such as paper, plastic, cellulose. In this illustrative embodiment (FIG. 2), three porous platforms are depicted as an illustration: upper platform 88, middle platform 90, and lower platform (e.g., at the base) 92. The platforms are positioned to accommodate the passage of water droplets formed from the warm water flowing from the cooling coil. The shape, thickness, and location of each platform will be determined by various factors. They include: the amount of warm water entering the evaporator; the shape and opening size of the supply nozzle (mentioned below); and the degree of mixing that is required to enhance water evaporation and temperature reduction in the water.

As shown in FIG. 2, the warm water from a cooling coil (not shown) is directed into the evaporator/absorber via conduit 82, in the manner described previously. A supply of make-up water 83 is also directed to the evaporator/absorber, by way of the same conduit as the warm water, or by way of a separate conduit. The water is preferably introduced through nozzle 84.

As the water leaves the nozzle, it usually becomes super-heated, due to the sudden drop in pressure. The super-heated water breaks up into droplets 86, and some portion of the water is converted into vapor, due to vigorous boiling. As alluded to above for the illustrated embodiment, the water droplets first contact upper platform 88, and this initial impact can enhance evaporation, e.g., by reducing a temperature difference that may exist between the central “core” of each water droplet, and its outer surface.

In the illustrated embodiment of FIG. 2, the water droplets pass through a succession of porous platforms 88, 90, and 92. In this manner, a substantial amount of heat is released from the warm water, and the temperature of the water becomes cool enough for recirculation back to the cooling coil, via conduit 94. The platforms also advantageously minimize the amount of water that might otherwise splash into absorber 78. In this embodiment, the concentrated desiccant solution from the regenerator (not shown) is directed to the absorber 78, usually through conduit 96. Within vacuum chamber 79, the desiccant comes into contact with the water vapor from evaporator 80. In the manner described above, the desiccant absorbs the water vapor and becomes diluted, and can then be directed back to the regenerator through conduit/pathway 98, depicted in simple form. The heat from the absorption can be released to the cooling water from the cooling tower (not shown in this figure), as described previously. Pathway arrows 99 and 101 provide a simplistic depiction of a water pathway into and out of the absorber/evaporator system, respectively.

One key advantage for the evaporator depicted in FIG. 2 is that the central region 85 of evaporator 80 is free of heat exchange tubes, and is instead based on a stream of water droplets moving through a pattern of porous structures. In contrast, conventional evaporator systems require heat exchange tubes in the central area of the evaporator. The “tubeless” evaporator exhibits less thermal resistance than a conventional evaporator, since bundles of tubes can be the source of considerable thermal resistance. Elimination of the tubes can also reduce the cost of the evaporator.

Another advantage residing in the overall cooler system design of the present invention is the absence of a condenser for condensing water that is directed through the evaporator, as described previously. In this regard, the cooling system is simplified as compared to some of the prior art systems, which always require the use of a condenser device. The elimination of this type of condenser device can also decrease the overall cost of the system and process.

Yet anther advantage of this cooling system design lies in the fact that the thermal resistance between the processed air and the refrigerant (water) is smaller than that present for a conventional absorption chiller. This is due in part to the fact that the refrigerant directly contacts the coolant, without any intervening metallic walls. This low-resistance design is especially useful when air entering a power generation device has to be at a very low temperature.

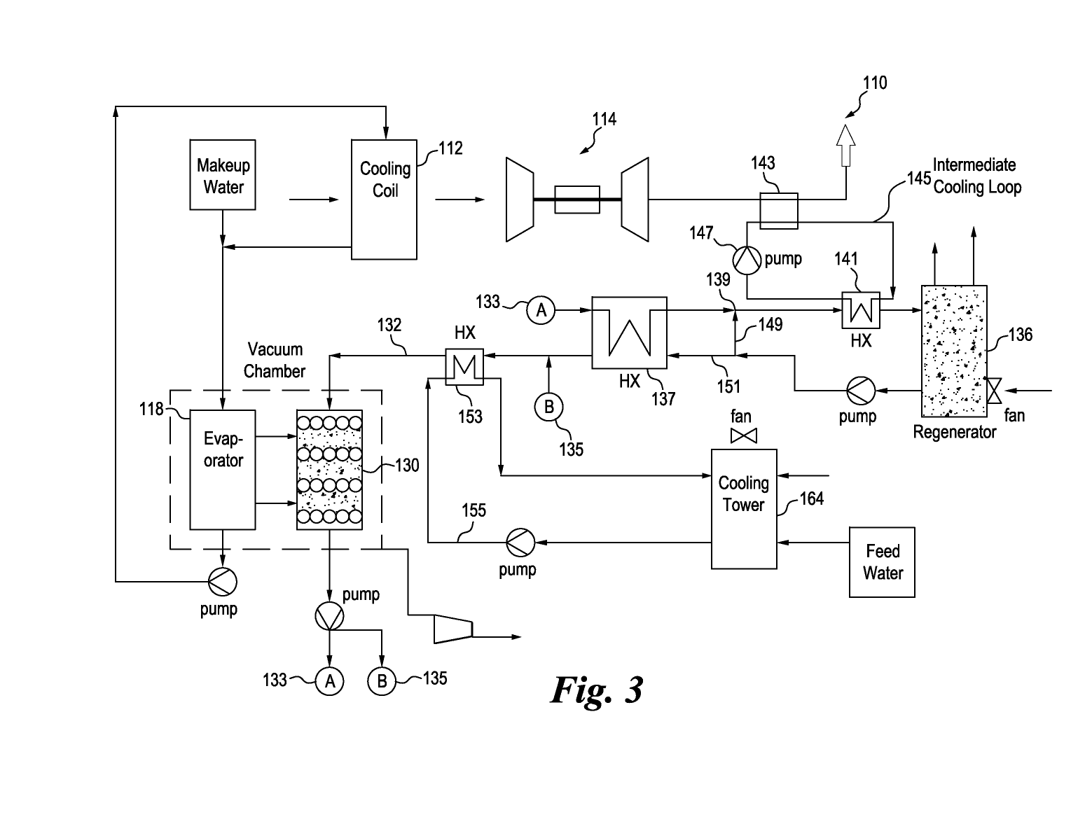

FIG. 3 is a schematic of an overall cooling system according to another embodiment of the invention. In this embodiment, multiple heat exchangers are employed along various pathways in the system. (In the figure, features and units that are similar to those of FIG. 1 may not be labelled). The cooling system 110 includes cooling coil 112, serving the function described previously, e.g., supplying cold air to gas turbine engine 114, or another type of engine or device requiring such air. The warm air and make-up water is directed through evaporator 118, contained within a vacuum chamber along with absorber 130. The absorber also accommodates the flow of desiccant 132, capable of absorbing water moisture. As noted previously, the desiccant (usually a liquid) becomes diluted, and often rises in temperature.

In the embodiment of FIG. 3, the relatively warm, diluted desiccant is divided into two streams, 133 and 135 (shown in truncated form at two locations of the figure, for the sake of simplicity). First stream 133 (the “A” stream) enters a first heat exchanger 137, where the desiccant absorbs additional heat from another desiccant stream 151, described below, which is a portion of the return-stream from the regenerator. (The content and amount of flow through the various streams in the cooling system are controlled in a manner which substantially balances water flow and desiccant flow into and out of the absorber and evaporator units).

The desiccant stream, now residing at a higher temperature after exiting heat exchanger 137, is directed along pathway 139, to a second heat exchanger 141. The second heat exchanger also receives heat from an external source 143, e.g., gas turbine exhaust, as in FIG. 1, thereby “boosting” the temperature of the desiccant, which can be advantageous. In some embodiments, as shown in FIG. 3, heat exchanger 141 and external heat source 143 can constitute an intermediate cooling loop 145, with the aid of pump 147.

After leaving heat exchanger 141, the diluted desiccant is then routed to regenerator 136. As described above for other embodiments, the desiccant comes into contact with external air in the regenerator, and gives off moisture, so that it can be re-used in its primary function. After leaving regenerator 136, the concentrated desiccant is divided into two streams, 149 and 151.

First return stream 149 is directed to pathway 139, to be mixed with the diluted regenerator material, prior to its entry into heat exchanger 141. Second return stream 151 is directed back to heat exchanger 137, to reject at least a portion of its heat content. The resulting stream from heat exchanger 137 is then combined with incoming, second stream 135 (the “B” stream noted above), and directed to third heat exchanger 153. As the desiccant is passed through this heat exchanger, it rejects additional heat to the fluid on the opposite side (the “cold side”) of the heat exchanger. The relatively cold desiccant is then directed through pathway 132 to the absorber, to renew its function of absorbing water moisture. Heat released from heat exchanger 153 can be directed to cooling tower 164, which can also form a cooling loop 155 with this heat exchanger.

The embodiment of FIG. 3 can include other features as well, most of which were discussed previously. For example, a pump can be used to remove non-dissolvable gasses from the vacuum chamber. Also, as explained with reference to FIG. 2, the absorber and evaporator can be effectively combined in some designs. Moreover, in some cases, the cooling coil (in this embodiment or that of FIG. 1) can be replaced with a direct-contact heat exchanger, allowing air to directly contact the cooling water. The embodiment of FIG. 3 is advantageous in some circumstances, because the multiple heat exchange units can more efficiently utilize excess heat that is generated throughout the cooling system.

Another embodiment of the invention relates to gas turbine engines. As those skilled in the art understand, and in reference to FIG. 1, engines of this type usually include a compressor 16, in communication with a combustor 19, and a power-delivery device 21, such as a turbine, in flow-communication with the compressor. The gas turbine further includes a cooling system like that described above, coupled in flow communication with an inlet region of compressor 16. The cooling coil effectively provides chilled air to the compressor, resulting in greater engine efficiency. Moreover, in some embodiments, excess exhaust generated by the gas turbine engine can be used to heat a desiccant material (e.g., via heat exchanger 52) that is being regenerated for use in the absorber 30 of the cooling system. Use of the excess heat from the turbine engine for this purpose can also increase the efficiency of the cooling system. As noted previously, methods for providing relatively cool air, or chilled air, to the gas turbine engine, using the cooling system described herein, constitutes another embodiment of the invention.

It will be apparent to those of ordinary skill in this area of technology that other modifications of this invention (beyond those specifically described herein) may be made, without departing from the spirit of the invention. Accordingly, the modifications contemplated by those skilled in the art should be considered to be within the scope of this invention. Furthermore, all of the patents, patent articles, and other references mentioned above are incorporated herein by reference.

What is claimed:

1. A cooling system for providing chilled air, comprising
(a) a cooling coil configured to accept air at a higher temperature and emit air at a lower temperature by passage through a flow of coolant water in the coil, resulting in a content of relatively warm water;
(b) an evaporator contained within a vacuum chamber, and in communication with the cooling coil; said evaporator configured to allow the passage of the relatively warm water therethrough, and to absorb heat from the warm water, thereby reducing the temperature of the water, while also forming a content of water vapor;
(c) an absorber contained in the vacuum chamber, and configured to accept the water vapor formed in the evaporator; while also configured to accommodate the flow of a concentrated desiccant that is capable of absorbing the water vapor and thereby becoming diluted and heated;
(d) an external heat source in contact with at least a portion of the desiccant, so as to further heat the desiccant;
(e) a regenerator that is capable of receiving at least a portion of the further-heated desiccant, said regenerator configured to accept and direct external air to the desiccant, thereby causing a release of at least some of the water content in the desiccant, to the atmosphere, so as to re-concentrate the desiccant to a selected concentration value;
(f) at least one heat exchanger that is capable of accepting the re-concentrated desiccant and lowering the temperature of the desiccant to a temperature that allows the desiccant to absorb water vapor formed in the evaporator, said heat exchanger being in communication with the absorber, to allow the return of the lower-temperature desiccant to the absorber; and
(g) a source of make-up water in communication with the cooling coil, configured to replenish water lost during operation of the cooling system.

2. The cooling system of claim 1, further comprising pumping means for removing non-dissolvable gasses from the vacuum chamber.

3. The cooling system of claim 1, wherein the evaporator is configured to absorb enough heat from the warm water to lower the temperature of the water by at least about 2° C.

4. The cooling system of claim 3, comprising means for returning the lower-temperature water to the cooling coil.

5. The cooling system of claim 1, further comprising a power generation device that receives the chilled air as part of a power generation cycle.

6. The cooling system of claim 5, wherein the power generation device includes a thermal outlet for discharging waste heat.

7. The cooling system of claim 6, wherein the thermal outlet comprises the external heat source that is capable of further heating the desiccant.

8. The cooling system of claim 7, wherein the thermal outlet is capable of providing heat at a temperature in the range of about 400° C. to about 550° C.

9. The cooling system of claim 1, wherein the desiccant comprises at least one material selected from the group consisting of lithium chloride (LiCl), lithium bromide (LiBr), calcium chloride (CaCl₂), zinc bromide, alkali nitrates, ionic liquids; activated carbon, zeolites, and silica gel.

10. The cooling system of claim 1, free of a condenser for condensing water vapor.

11. The cooling system of claim 1, wherein the evaporator (b) is configured to function in the absence of a cooling coil.

12. The cooling system of claim 1, wherein the evaporator (b) is configured to include at least one platform comprising a porous medium, positioned to accommodate the passage of water droplets formed from the warm water flowing from the cooling coil.

13. The cooling system of claim 1, further comprising a conduit between the external heat source and the regenerator, so as to allow additional heat to regenerate the desiccant.

14. A gas turbine engine, comprising:
I) a compressor;
II) a combustor;
III) a turbine, coupled in flow communication with the compressor; and
IV) a cooling system coupled in flow communication with an inlet region of the compressor; so as to provide cooling air to the inlet region; wherein the cooling system comprises:
(a) a cooling coil configured to accept air at a higher temperature and emit air at a lower temperature by passage through a flow of coolant water in the coil, resulting in a content of relatively warm water;
(b) an evaporator contained within a vacuum chamber, and in communication with the cooling coil; said evaporator configured to allow the passage of the relatively warm water therethrough, and to absorb heat from the warm water, thereby reducing the temperature of the water, while also forming a content of water vapor;
(c) an absorber contained in the vacuum chamber, and configured to accept the water vapor formed in the evaporator; while also configured to accommodate the flow of a concentrated desiccant that is capable of absorbing the water vapor and thereby becoming diluted and heated;
(d) an external heat source in contact with at least a portion of the desiccant, so as to further heat the desiccant;
(e) a regenerator that is capable of receiving at least a portion of the further-heated desiccant, said regenerator configured to accept and direct external air to the desiccant, thereby causing a release of at least some of the water content in the desiccant, so as to re-concentrate the desiccant to a selected concentration value;
(f) at least one heat exchanger that is capable of accepting the re-concentrated desiccant and lowering the temperature of the desiccant to a temperature that allows the desiccant to absorb water vapor formed in the evaporator, said heat exchanger being in communication with the absorber, to allow the return of the lower-temperature desiccant to the absorber.

15. A method for providing chilled air to a gas turbine engine that includes a compressor; a combustor; and a turbine coupled in flow communication with the compressor, comprising the steps of:
(i) flowing relatively warm air through coolant water in a cooling coil, and then into an inlet in the compressor, wherein the cooling coil transforms the relatively warm air into chilled air; and wherein the interaction of the warm air with the coolant water transforms the water into relatively warm water;
(ii) directing the relatively warm water through an evaporator contained within a vacuum chamber, and in communication with the cooling coil; wherein the evaporator is configured to allow the passage of the relatively warm water therethrough, and to absorb heat from the warm water, thereby reducing the temperature of the water so that it can be directed back to the cooling coil; while also forming a content of water vapor;
(iii) directing the water vapor from the evaporator to an absorber; while also directing a concentrated desiccant to the absorber, so that the desiccant absorbs the water vapor and becomes diluted with a content of water.
(iv) contacting the heated, diluted desiccant with an external heat source, so as to further increase the temperature of the desiccant;
(v) directing at least a portion of the further-heated desiccant to a regenerator and exposing the desiccant to external air directed into the regenerator, so as to cause a release of at least some of the water content in the desiccant, thereby re-concentrating the desiccant to a selected concentration value; and
(vi) directing the re-concentrated desiccant to the absorber.
